(19) United States
(12) Patent Application Publication
(10) Pub. No.: US 2003/0001384 A1
(43) Pub. Date: Jan. 2, 2003

(54) Seal cap and connector assembly

(76) Inventor: James E. Carroll, Novi, MI (US)

Correspondence Address: IRVING M. WEINER, WEINER & BURT, P.C., 635 N. US-23, P.O. BOX 186, HARRISVILLE, MI, 48740, US

(21) Appl. No.: 10/185,175

(22) Filed: Jun. 28, 2002

Related U.S. Application Data
(60) Provisional application No. 60/301,548, filed on Jun. 28, 2001.

(51) Int. Cl. F16J 15/00; F16L 55/00

(52) U.S. Cl. 285/45; 285/86; 285/321

(57) ABSTRACT

A moisture-proof and dust-proof seal cap for assembly over a previously end-formed tube. The invention also provides a connector assembly which includes the seal cap that can move onto the female member by an interference fit. The seal cap is compact, easily assembled and disassembled without tools to and from the connector assembly.

The present utility patent application claims priority from U.S. Provisional Patent Application Serial No. 60/301,548 filed Jun. 28, 2001.

The present invention relates to a seal cap, and a fluid connector assembly using said seal cap.

### BACKGROUND OF THE INVENTION

It is well known in the prior art to provide a fluid connector assembly including a male member from which the fluid line extends and a female member connected to a receptacle for the fluid. For example, in the automotive industry, fluid lines are connected at one end to an automatic transmission and at another end to a cooler disposed within the header of a radiator. It is also known to provide a resilient member carried on the female member adapted to snap beneath a shoulder portion of the male member when inserted into the female member to lock the male member in place. The male member may be removed from the female member by expansion of the resilient member with the use of a simple tool, such as a screwdriver. The area of access to the connector assembly for assembly and disassembly is typically limited.

The present invention provides a novel seal cap, and an improvement to existing connector assemblies, such as, for example, the assembly disclosed by Lu et al. U.S. Pat. No. 5,749,606.

It is a desideratum of the present invention to eliminate and/or avoid the animadversions of conventional and/or prior devices and techniques.

It is a desideratum of the present invention to eliminate and/or avoid the animadversions of conventional and/or prior devices and techniques.

### SUMMARY OF THE INVENTION

The present invention provides a novel moisture-proof and dust-proof seal cap for assembly over a previously end-formed tube.

The present invention also provides a connector assembly which includes the aforesaid seal cap that can move onto the female member by an interference fit. The seal cap is compact, easily assembled and disassembled without the use of tools to and from the connector assembly.

The present invention provides a moisture-proof and dust-proof seal cap, comprising: a seal cap which is integrally fabricated from a resilient material; said seal cap includes a central body portion having an exterior surface with a reduced outer diameter; said central body portion being axially positioned between first and second flanges having externally enlarged outer diameters in comparison to said central body portion; said seal cap including on a first side thereof an annular portion and a flexing portion; said flexing portion permitting flexing without stretching the top of said seal cap when there is slight relative motion; and said seal cap forming a moisture-proof and dust-proof seal to whatever external member on which said seal cap may be assembled.

The present invention provides a connector assembly, comprising: a female member having a bore extending therethrough; a male member for insertion into said bore of said female member, said male member having a shoulder portion thereon; a resilient member disposed on said female member and extending partially into said bore, said resilient member engaging said shoulder portion of said male member to lock said male member in position within said female member; a moisture-proof and dust-proof seal cap fabricated from a resilient material; said seal cap including a central body portion having an exterior surface with a reduced outer diameter; said central body portion being actually positioned between first and second flanges having externally enlarged outer diameters in comparison to said central body portion; said seal cap including on a first side thereof an annular portion and a flexing portion; said flexing portion permitting flexing without stretching the top of said seal cap when there is slight relative motion; said central body portion of said seal cap including an internal surface sized for enabling said seal cap to be assembled over a predetermined portion of said male member; said seal cap has a main inner diameter defined by a radially-inward edge of said first flange; and said main inner diameter being sized sightly smaller than predetermined portions of said female member to enable said seal cap to move onto said female member by way of an interference fit.

The present invention provides a method of assembling a connector assembly including a male member secured to a fluid line and having an actually extending tapered portion terminating at a shoulder portion, said male member having an axial axis including an axial length, a female member including a bore therethrough for receiving said male member therein, and a resilient member disposed on said female member and extending partially into said bore, the method comprising the steps of: providing a moisture-proof and dust-proof resilient seal cap; connecting said seal cap to said male member; axially inserting said male member into said female member by radial expansion of said resilient member by the tapered portion of said male member while keeping said seal cap completely spaced apart from said female member and completely out of engagement with said female member, said resilient member, and said shoulder portion of said male member; and prior to insertion of said male member, said seal cap is disposed on a reduced diameter portion of said male member by interference fit.

### BRIEF DESCRIPTION OF THE DRAWINGS

FIG. 1 is a perspective view of a seal cap according to a first embodiment of the present invention.

FIG. 2 is an elevational view taken from the right side of seal cap as illustrated in FIG. 1.

FIG. 3 is a partially-exploded view of a connector assembly according to a second embodiment of the present invention including the seal cap, which is shown in FIGS. 1 and 2, with the male member inserted into the female member.

### DESCRIPTION OF THE PREFERRED EMBODIMENT

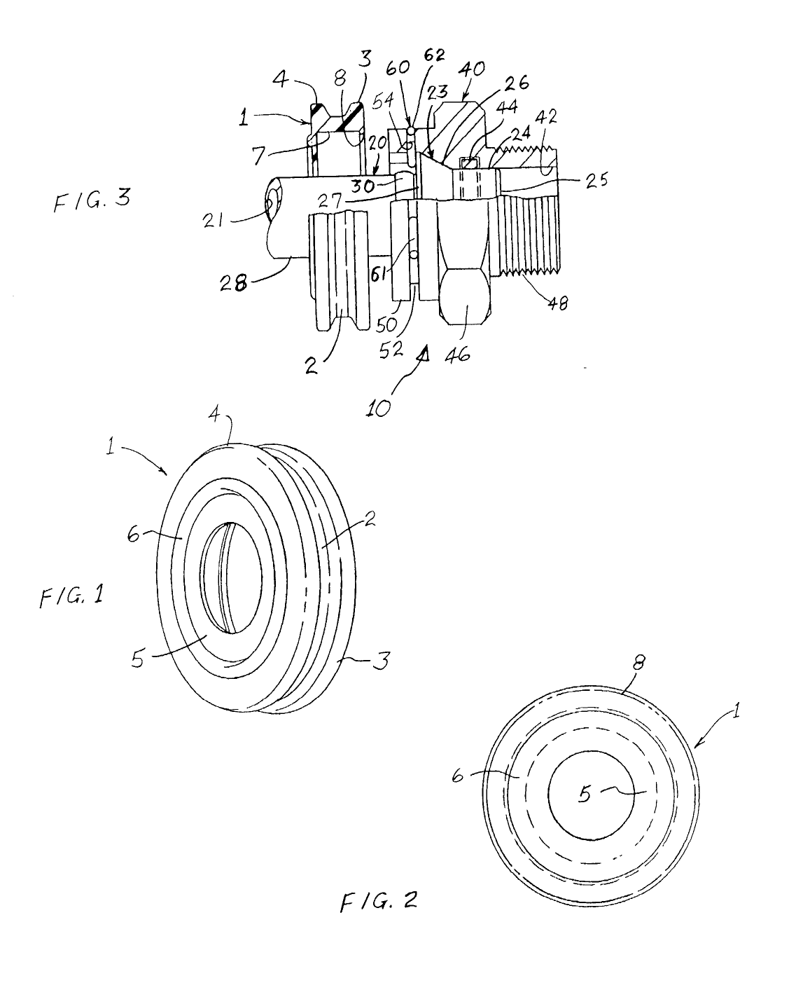

FIGS. 1 and 2 illustrate a moisture-proof and dust-proof seal cap 1 in accordance with a first embodiment of the present invention.

The seal cap 1 is preferably, but not necessarily, integrally formed of a single material. Preferably, but not necessarily, the seal cap 1 is integrally fabricated from a resilient material, such as rubber, or Santoprene, or any suitable resilient material.

The seal cap 1 includes a central body portion 2 having an exterior surface with a reduced outer diameter. The central body portion 2 is axially positioned between first and second flanges 3 and 4, respectively, having externally enlarged outer diameters in comparison to the central body portion 2. The flanges 3, 4 are preferably, but not necessarily, of equal size.

The seal cap 1 includes on one side thereof an annular portion 5 and a flexing portion 6. The flexing portion 6 allows flexing without stretching the top of the seal cap 1 when there is slight relative motion.

The seal cap 1 forms a moisture-proof and dust-proof seal to whatever external body on which the seal cap 1 may be assembled.

With reference to FIG. 3, there is shown a fluid connector assembly, indicated generally as 10, which can be used to connect a fluid line to a threaded port in a vehicle structure (not shown) such as an automatic transmission or a radiator. The connector assembly 10 preferably, but not necessarily, includes five components: a male member 20; a female member 40 for threaded connection to the port; a sealing O-ring 44 (described hereinbelow); a resilient member 60 disposed on the female member 40; and the seal cap 1 which is disposed on the male member 20 and which moves onto the female member 40 by an interference fit when the male member 20 is fully assembled to the female member 40.

The male member 20 is preferably, but not necessarily, made of a metallic material and has a male member bore 21 extending entirely therethrough. The male member 20 includes a head portion 23 including a straight portion 24 terminating in a free end 25 of the head portion 23 and a radially outwardly tapered portion 26. The tapered portion 26 gradually increases in a direction away from the free end 25 and terminates in a shoulder portion 27 connected to a reduced diameter portion 28 of the male member 20. The reduced diameter portion 28 of the male member 20 preferably, but not necessarily, is an elongated fluid line having a generally constant diameter and which is preferably, but not necessarily, integrally formed with the head portion 23, but which may be also suitably connected thereto in a conventional manner. Preferably, but not necessarily, an insertion indicator feature 30 is located on the reduced diameter portion 28 of the male member 20 adjacent the shoulder portion 27. The insertion indicator feature 30 preferably, but not necessarily, comprises a radially-raised portion which may also be painted or otherwise colored (not shown) for visual and tactile distinction from the rest of the reduced diameter portion 28 of the male member 20. When the male member 20 is inserted into the female member 40, as shown in FIG. 3, the insertion indicator feature 30 is positioned within the female member 40 and cannot be detected upon inspection.

The female member 40 is preferably, but not necessarily, integrally made from a single piece of metallic material and has a female member bore 42 extending entirely therethrough. An O-ring 44 may be provided in the female member bore 42 to prevent fluid leakage after assembly of the male member 20 therein The exterior body of the female member 40 has a central enlarged hexagonal outwardly-projecting portion 46 disposed between a reduced diameter threaded portion 48 and a reduced diameter receiving portion 50. The threaded portion 48 can be threaded into the threaded port of the structure simply by turning the hexagonal outwardly-projecting portion 46 until a fluid tight seal has been accomplished. A sealing compound (not shown) may be disposed on the threaded portion 48 to assist in maintaining a fluid tight seal. The receiving portion 50 of the female member 40 is preferably, but not necessarily, externally sized slightly larger than the threaded portion 48, but smaller than the outwardly projecting portion 46. The receiving portion 50 of the female member 40 preferably, but not necessarily, has a generally-constant outer diameter. The receiving portion 50 of the female member 40 includes a receiving groove 52 thereon which is axially spaced apart from the outwardly-projecting portion 46. The receiving groove 52 of the female member 40 is provided with circumferentially spaced apart slotted apertures 54 which extend between the receiving groove 52 and into the female member bore 42.

The resilient member 60 is preferably, but not necessarily, formed of a single piece of spring wire. The resilient member 60 is preferably, but not necessarily, formed with inwardly-extending lobes 61 interconnected by outer portions 62. It will be appreciated that many variations of the resilient member 60 are possible and that more than one resilient member may be provided. To assemble the resilient member 60 to the female member 40, the resilient member 60 is snapped into the receiving groove 52 from the exterior side of the female member 40. In the assembled condition, the resilient member 60 is disposed on the receiving portion 50 and the lobes 61 of the resilient member 60 each extend through the slotted apertures 54. The lobes 61 are adapted to engage the shoulder portion 27 of the head portion 23 to hold the male member 20 within the female member 40 after insertion therein, as described further hereinafter. When the resilient member 60 is seated in the receiving groove 52 of the female member 40, the resilient member 60 is preferably, but not necessarily, in a relaxed condition, neither expanded or compressed. Also preferably, but not necessarily, when the resilient member 60 is seated in the receiving groove 52, the resilient member 60 is sized to have an overall dimension approximately equal to or slightly less than the outer diameter of the receiving portion 50 of the female member 40.

The central body portion 2 of the seal cap 1 includes an internal surface 7 sized for enabling the seal cap 1 to be assembled over an external member, such as a previously end-formed tube or the male member 20. The seal cap 1 has a main inner diameter 8 defined by the radially-inward edge of the first flange 3. The main inner diameter 8 is sized slightly smaller than predetermined portions of the female member 40 to enable the seal cap 1 to move onto the female member 40 by way of an interference fit. The seal cap 1 is axially dimensioned such that the surface 7 is axially aligned with the resilient member 60 when the seal cap 1 abuts the receiving portion 50 of the female member 40 after assembly of the seal cap 1 onto the female member 40.

The main inner diameter 8 of the seal cap 1 is sized approximately equal to or only slightly larger than the outer diameter of the receiving portion of the female member 40.

Prior to insertion of the male member 20, the seal cap 1 is preferably, but not necessarily, disposed on the reduced diameter portion 28 of the male member 20 by interference fit. Preferably, but not necessarily, the diameter of the inner central aperture of the annular portion 5 is approximately equal to or less than the outer diameter of the reduced diameter portion (tube) 28 of the male member 20.

As a final assembly step, the seal cap 1 is simply axially pushed onto the receiving portion 50 of the female member 40 until the surface 7 of the seal cap 1 is axially aligned with the resilient member 60.

The seal cap 1 may be assembled and disassembled without the use of any tools. The seal cap 1 made of a resilient material, is lightweight and takes relatively little space in the assembly.

It will be understood that a person skilled in the art may make modifications to the specific embodiments shown herein within the scope and spirit of the present invention.

While the present invention has been described as carried out in specific embodiments thereof, it is not intended to be limited thereby; but is intended to cover the invention broadly.

1. A moisture-proof and dust-proof seal cap, comprising:
a seal cap which is integrally fabricated from a resilient material;
said seal cap includes a central body portion having an exterior surface with a reduced outer diameter;
said central body portion being axially positioned between first and second flanges having externally enlarged outer diameters in comparison to said central body portion;
said seal cap including on a first side thereof an annular portion and a flexing portion;
said flexing portion permitting flexing without stretching the top of said seal cap when there is slight relative motion; and
said seal cap forming a moisture-proof and dust-proof seal to whatever external member on which said seal cap may be assembled.

2. A seal cap according to claim 1, wherein:
said first and second flanges are of substantially equal size.

3. A seal cap according to claim 1, wherein:
said central body portion includes an internal surface sized for enabling said seal cap to be assembled over said external member.

4. A seal cap according to claim 2, wherein:
said central body portion includes an internal surface sized for enabling said seal cap to be assembled over said external member.

5. A seal cap according to claim 1, wherein:
said seal cap has a main inner diameter which is defined by a radially-inward edge of said first flange.

6. A seal cap according to claim 2, wherein:
said seal cap has a main inner diameter which is defined by a radially-inward edge of said first flange.

7. A seal cap according to claim 3, wherein:
said seal cap has a main inner diameter which is defined by a radially-inward edge of said first flange.

8. A seal cap according to claim 4, wherein:
said seal cap has a main inner diameter which is defined by a radially-inward edge of said first flange.

9. A connector assembly, comprising:
a female member having a bore extending therethrough;
a male member for insertion into said bore of said female member, said male member having a shoulder portion thereon;
a resilient member disposed on said female member and extending partially into said bore, said resilient member engaging said shoulder portion of said male member to lock said male member in position within said female member;
a moisture-proof and dust-proof seal cap fabricated from a resilient material;
said seal cap including a central body portion having an exterior surface with a reduced outer diameter;
said central body portion being actually positioned between first and second flanges having externally enlarged outer diameters in comparison to said central body portion;
said seal cap including on a first side thereof an annular portion and a flexing portion;
said flexing portion permitting flexing without stretching the top of said seal cap when there is slight relative motion;
said central body portion of said seal cap including an internal surface sized for enabling said seal cap to be assembled over a predetermined portion of said male member;
said seal cap has a main inner diameter defined by a radially-inward edge of said first flange; and
said main inner diameter being sized sightly smaller than predetermined portions of said female member to enable said seal cap to move onto said female member by way of an interference fit.

10. A connector assembly according to claim 9, wherein:
said seal cap is actually dimensioned such that said internal surface is actually aligned with said resilient member when said seal cap abuts the receiving portion of said female member after assembly of said seal cap onto said female member.

11. A connector assembly according to claim 9, wherein:
said main inner diameter of said seal cap is sized approximately equal to or only slightly larger than the outer diameter of the receiving portion of said female member.

12. A connector assembly according to claim 10, wherein:
said main inner diameter of said seal cap is sized approximately equal to or only slightly larger than the outer diameter of the receiving portion of said female member.

13. A method of assembling a connector assembly including a male member secured to a fluid line and having an actually extending tapered portion terminating at a shoulder portion, said male member having an axial axis including an axial length, a female member including a bore therethrough for receiving said male member therein, and a resilient member disposed on said female member and extending partially into said bore, the method comprising the steps of:
providing a moisture-proof and dust-proof resilient seal cap;
connecting said seal cap to said male member;
axially inserting said male member into said female member by radial expansion of said resilient member by the tapered portion of said male member while keeping said seal cap completely spaced apart from said female member and completely out of engagement with said female member, said resilient member, and said shoulder portion of said male member; and
prior to insertion of said male member, said seal cap is disposed on a reduced diameter portion of said male member by interference fit.

14. A method according to claim 13, wherein:
the diameter of an inner central aperture of an annular portion of said seal cap is approximately equal to or less than the outer diameter of said reduced diameter portion of said male member.

15. A method according to claim 13, wherein:
as a final assembly step, said seal cap is simply axially pushed onto said receiving portion of said female member until said internal surface of said seal cap is axially aligned with said resilient member.

16. A method according to claim 14, wherein:
as a final assembly step, said seal cap is simply axially pushed onto said receiving portion of said female member until said internal surface of said seal cap is axially aligned with said resilient member.

17. A method according to claim 13, wherein:
said seal cap may be assembled and disassembled without the use of any tools.

18. A method according to claim 14, wherein:
said seal cap may be assembled and disassembled without the use of any tools.

19. A method according to claim 15, wherein:
said seal cap may be assembled and disassembled without the use of any tools.

20. A method according to claim 16, wherein:
said seal cap may be assembled and disassembled without the use of any tools.
